(19) United States
(12) Patent Application Publication
(10) Pub. No.: US 2024/0024193 A1
(43) Pub. Date: Jan. 25, 2024

(54) MASSAGING DEVICE AND METHOD OF FABRICATING THE SAME

(71) Applicant: SHENZHEN QILEYUAN HEALTH PRODUCTS CO., LTD, Shenzhen City (CN)

(72) Inventor: LEISHENG YAN, NANYANG CITY (CN)

(21) Appl. No.: 17/868,902

(22) Filed: Jul. 20, 2022

(51) Int. Cl. A61H 23/02; B29C 45/40

(52) U.S. Cl. CPC A61H 23/0254; B29C 45/40; A61H 2201/0157; A61H 2201/0153; B29C 2045/4089

(57) ABSTRACT

A massaging device and a method of fabricating the same are provided. The massaging device comprises a soft outer body, a vibration motor, a control device, a power supply unit, and a soft filler. The method comprises: preparing mold and materials; assembling mold core into the outer mold; injecting a raw material of a soft outer body into the outer mold; after the raw material of the soft outer body is molded, taking out the mold core; assembling the vibration motor, control device and power supply unit to the lower side of the positioning fixture, and placing the positioning fixture on the top of the outer mold, so that the vibration motor, control device and power supply unit are placed in the cavity; injecting the soft filler raw material into the cavity; taking out the positioning fixture; and placing the pressing mold on the top of the outer mold.

### FIELD OF THE DISCLOSURE

The present disclosure relates to the technical field of massaging devices, in particular, to a massaging device and a method of fabricating the same.

### BACKGROUND OF THE DISCLOSURE

Massaging devices are a new generation of health care equipment developed based on physics, bionics, bioelectrics, traditional Chinese medicine and many years of clinical practice.

However, in the existing massaging devices, the motor and controller need to have an extra shell or bracket to support and protect. Although the silicone jacket will be put on after assembly, when the product is used, there will be a large foreign body sensation, which reduces the user's experience.

### SUMMARY OF THE DISCLOSURE

The purpose of the present disclosure is to provide a massaging device and a method of fabricating the same in view of the defects and deficiencies of the prior art, which have the advantages of greatly reducing the foreign body sensation of the product and improving the user experience.

For achieving the above object, the technical solution adopted in the present disclosure is to provide a massaging device, comprising: a soft outer body having a cavity; a vibration motor, arranged in the cavity; a control device, arranged in the cavity and electrically connected to the vibration motor, for controlling the vibration motor to operate; a power supply unit, arranged in the cavity and electrically connected to the control device, for supplying power to the vibration motor and the control device; and a soft filler filled in the cavity, wherein the soft filler is configured to seal, the control device and the power supply unit in the cavity.

In preferred embodiments, each of the soft outer body and the soft filler is made of silica gel.

In preferred embodiments, one end of the massaging device is a massage end, and another end of the massaging device is a handheld end; the vibration motor is close to the massage end, and the control device is close to the hand-held end; the vibration motor and the control device are connected to each other through a wire.

In preferred embodiments, the wire is a stretchable wire.

In preferred embodiments, the power supply unit is fixedly assembled on the control device.

In preferred embodiments, a charging electrode is provided on the control device and the charging electrode is exposed from the soft outer body.

In preferred embodiments, a push switch is provided on the control device and the push switch faces a side of the soft outer body.

Another technical solution provided by the present disclosure is to provide a method of fabrication a massaging device, comprising the following steps:
step 1: preparing an outer mold, a mold core, a positioning fixture, a pressing mold, a soft outer body raw material, a soft filler raw material, a vibration motor, a control device and a power supply unit;
step 2: assembling the mold core into the outer mold;
step 3: injecting a raw material of a soft outer body into the outer mold;
step 4: after the raw material of the soft outer body is molded, taking out the mold core, wherein the raw material of the soft outer body molds the soft outer body and a cavity is formed in an original position of the mold core;
step 5: assembling the vibration motor, the control device and the power supply unit to a lower side of the positioning fixture, and placing the positioning fixture on a top of the outer mold so that the vibration motor, the control device and the power supply unit are placed in the cavity;
step 6: injecting the soft filler raw material into the cavity for filling;
step 7: taking out the positioning fixture; and
step 8: placing the pressing mold on the top of the outer mold, so that a top of the soft filler raw material is formed into a set shape.

In preferred embodiments, between step 7 and step 8, the method further includes the step of continuing to inject the soft filler raw material to fill a missing part.

In preferred embodiments, the method further includes a step of: drying and forming.

In preferred embodiments, a bottom of the outer mold corresponds to a massage end of a massaging device, and the end of the outer mold corresponds to a handheld end of the massaging device;

Wherein the control device is assembled to a lower side of the positioning fixture, the vibration motor is connected to a lower side of the control device through a wire, and the power supply unit is fixedly assembled on the control device;
wherein a charging electrode is provided on the control device, and the charging electrode faces the top of the outer mold;
wherein a push switch is provided on the control device, and the push switch faces a side of the outer mold.

In preferred embodiments, a top side of the outer mold is provided with an insertion hole, a lower side of the mold core is provided with a pin, and the insertion post is detachably inserted into the insertion hole; and
a notch is formed on a top side of the outer mold, and a first bump that protrudes outward and corresponds to the notch is arranged on the positioning fixture.

In preferred embodiments, a top side of the mold core is provided with a first handle.

In preferred embodiments, the positioning fixture is provided with a positioning structure, so that the control device is detachably assembled on a lower side of the positioning fixture and holds the charging electrode towards a top of the outer mold.

In preferred embodiments, the pressing mold is provided with a second bump that protrudes outward and corresponds to the notch, and a top side of the pressing mold is provided with a second handle.

In preferred embodiments, a bottom of the pressing mold is provided with a third bump, so that after the pressing mold is placed on a top of the outer mold, a charging port is formed on the handheld end of the massaging device, and the charging port corresponds to the charging electrode.

In preferred embodiments, the bottom of the pressing mold is in an arc shape with a high middle and a low circumference, so that a bottom of the hand-held end of the massaging device is an arc shape with a low middle and a high circumference.

After adopting the above-mentioned technical solution, the beneficial effects of the present disclosure are as follows.

In the present disclosure, the vibration motor and the control device do not need an additional shell or bracket to support and protect, they are directly placed in the cavity of the soft outer body, and then filled with soft fillers. The foreign body sensation of the product improves the user's experience.

### BRIEF DESCRIPTION OF THE DRAWINGS

In order to explain the embodiments of the present disclosure or the technical solutions in the prior art more clearly, the following briefly introduces the accompanying drawings that need to be used in the description of the embodiments or the prior art. Obviously, the drawings in the following description are only are some embodiments of the present disclosure. For those of ordinary skill in the art, other drawings can also be obtained based on these drawings without any creative effort.

FIG. 1 is a structural schematic diagram of the massaging device.

FIG. 2 is a schematic diagram of the structure of the vibration motor, control device and power supply unit, outer mold, mold core, positioning fixture.

FIG. 3 is a structural schematic diagram that the mold core is assembled into the outer mold.

FIG. 4 is a structural representation that the mold core is taken out.

FIG. 5 is a schematic structural diagram of the positioning fixture placed on the top of the outer mold.

FIG. 6 is a schematic structural diagram of the positioning fixture taking out.

FIG. 7 is a structural schematic diagram that the pressing mold is placed on the top of the outer mold.

FIG. 8 is a structural representation that presses the mold to take out.

FIG. 9 is a structural representation of pressing mold.

FIG. 10 is a block diagram of steps of a method fabrication of massaging device.

Reference numeral: 100. massaging device; 110. soft outer body; 120. vibration motor; 130. control device; 140. power supply unit; 150. wire; 160. charging electrode; 170. charging port; 180. push switch; 200. outer mold; 210. insertion hole; 220. gap; 300. mold core; 310. insertion post; 320. first handle; 400. positioning fixture; 410. first bump; 420. positioning structure; 500. press mold; 510. second bump; 520. second handle; 530. third bump; a. massage end; b. the hand-held end.

### DETAILED DESCRIPTION OF THE EXEMPLARY EMBODIMENTS

The present disclosure will be further described in detail below with reference to the accompanying drawings.

This specific embodiment is only an explanation of the present disclosure, and it is not a limitation of the present disclosure. Those skilled in the art may, after reading this specification, make modifications to this embodiment without creative contribution as required, and as long as they are within the scope of the claims of the present disclosure, they are protected by the patent law.

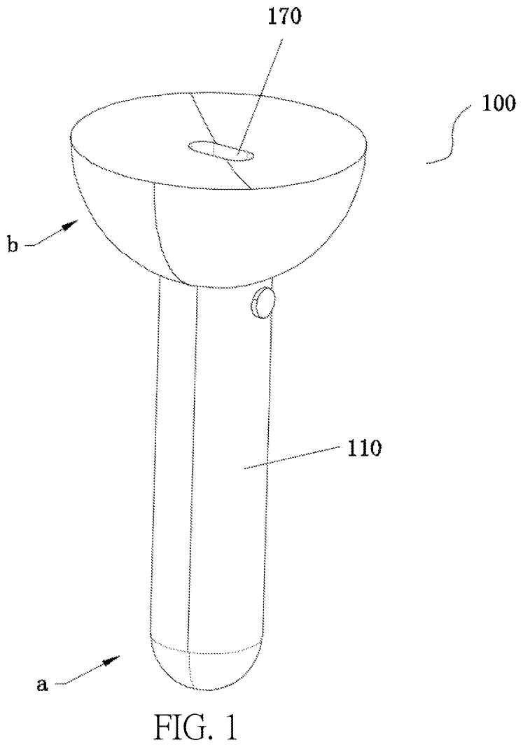

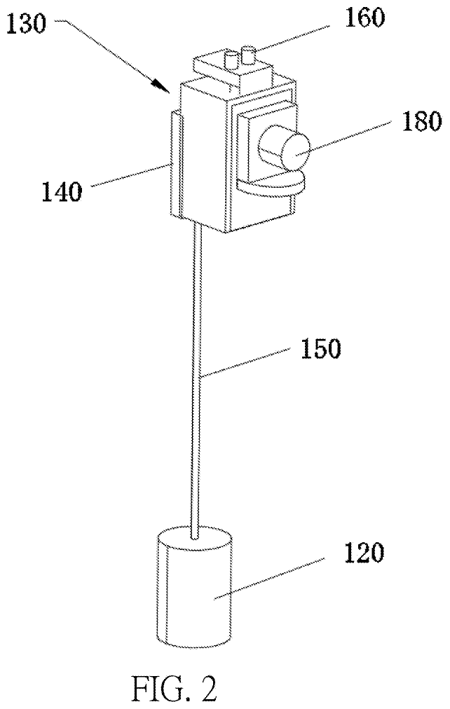

The present embodiment relates to a massaging device 100, as shown in FIG. 1 to FIG. 2, including: a soft outer body 110, a vibration motor 120, a control device 130, a power supply unit 140, and a soft filler. For the convenience of description and understanding, as shown in FIG. 1, one end of the actual massaging device 100 is the massage end a, and the other end is the hand-held end b. The massage end a acts on the human body to massage the human body. The hand-held end b is used for holding by the hand, and the hand-held end b can also be fixed on a wall, a desktop, or the like. The vibration motor 120 is close to the massage end a, which is used to generate vibration and drive the massage end a to massage the human body. The control device 130 is close to the hand-held end b.

The soft outer body 110 has a cavity. The vibration motor 120, the control device 130 and the power supply unit 140 are all arranged in the cavity. The soft filler is filled in the cavity, and the vibration motor 120, the control device 130 and the power supply unit 140 are sealed in the cavity.

Specifically, the control device 130 is electrically connected to the vibration motor 120 for controlling the vibration motor 120 to work. The power supply unit 140 is electrically connected to the control device 130 for supplying power to the vibration motor 120 and the control device 130.

The vibration motor 120 and the control device 130 do not need additional housing or brackets for support and protection, and are directly placed in the cavity of the soft outer body 110 and then filled with soft fillers. Since there is no housing or bracket, the product is greatly reduced. The foreign body sensation improves the user experience.

In this embodiment, both the soft outer body 110 and the soft filler are made of silica gel. In other embodiments, the soft outer body 110 and the soft filler can also use other soft materials.

In this embodiment, the vibration motor 120 and the control device 130 are connected through a wire 150. More preferably, the wire 150 is a stretchable wire. The length of the stretchable wire is adjusted according to the size of the actual product, so as to satisfy the use of products with different external dimensions and increase the versatility of the product.

Referring to FIG. 2, in this embodiment, the power supply unit 140 is electrically connected to the control device 130, and is fixedly assembled on the control device 130 through a strap. In other embodiments, the power supply unit 140 may also be fixed on the control device 130 in other manners. Referring to FIGS. 1-2, the control device 130 is provided with a charging electrode 160, and the charging electrode 160 is exposed on the soft outer body 110. Specifically, in this embodiment, the bottom surface of the hand-held end b is provided with a charging port 170 for charging. The electrode 160 corresponds to the charging port 170. By providing the charging electrode 160, the power supply unit 140 can be charged. The power supply unit 140 is a battery in this embodiment. Referring to FIG. 2, the control device 130 is provided with a push switch 180, and the push switch 180 faces the side of the soft outer body 110. During use, the user can touch the push switch 180 by pressing the side of the soft outer body 110 at the position corresponding to the push switch 180, and then the massaging device 100 can be activated or deactivated.

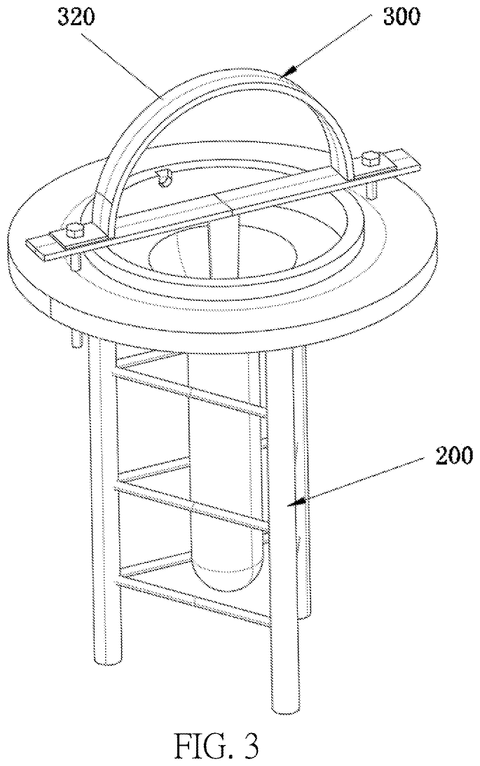

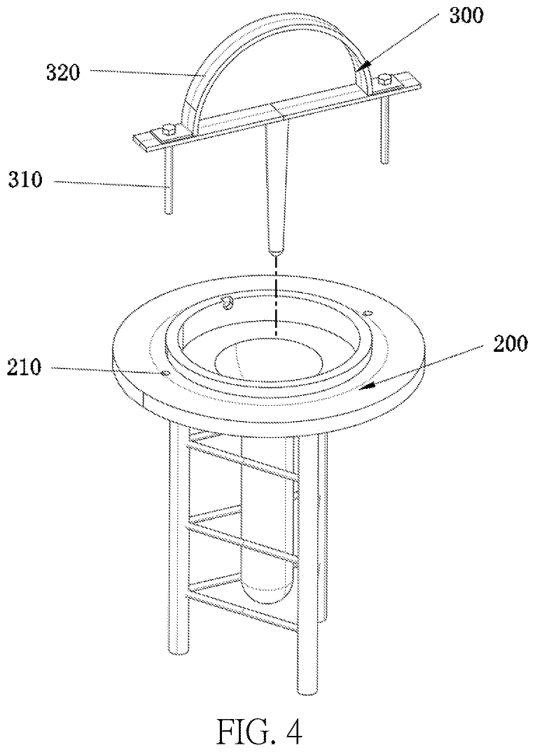

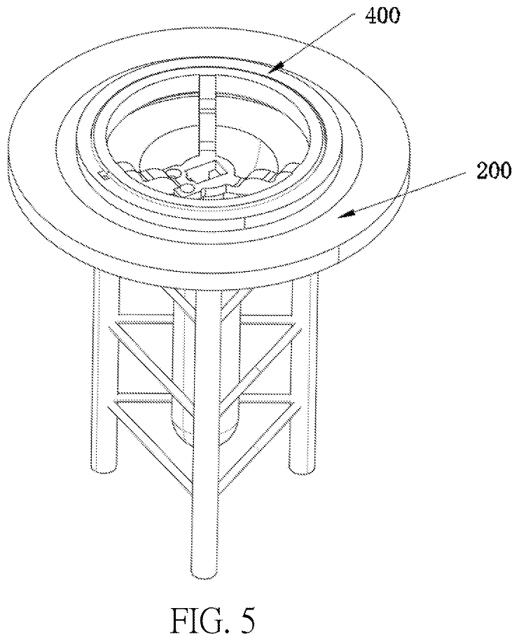

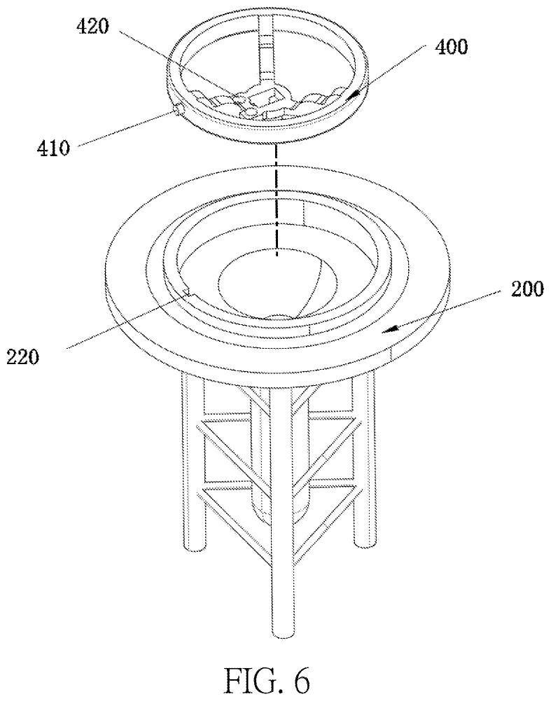

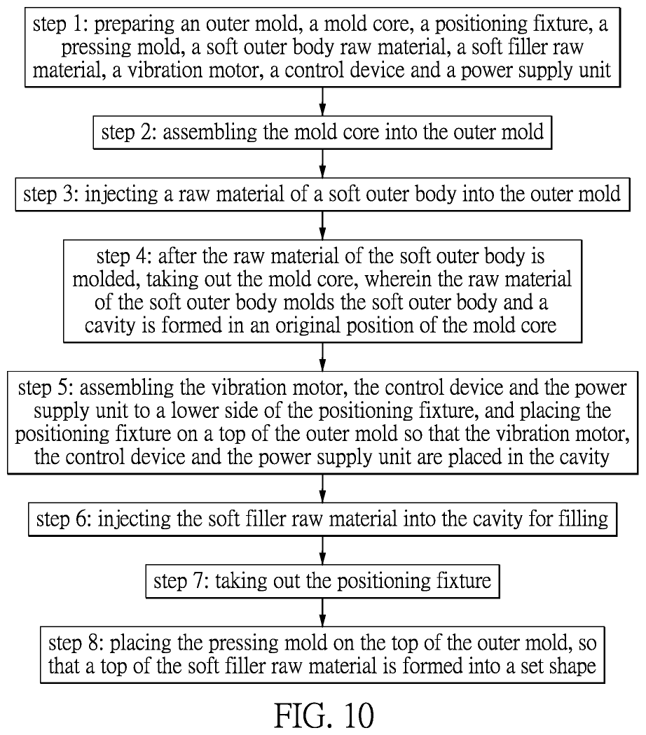

The present embodiment also provides a method of fabricating a massaging device 100, which can be used to manufacture the above-mentioned massaging device 100. Referring to FIG. 10, the method includes the following steps:
step 1: preparing the outer mold 200, the mold core 300, the positioning fixture 400, the soft outer body raw material, the soft filler raw material, the pressing mold 500, the vibration motor 120, the control device 130 and the power supply unit 140;
step 2: as shown in FIG. 3, assembling the mold core 300 into the outer mold 200;
step 3: injecting a raw material of the soft outer body 110 into the outer mold 200;
step 4: after the raw material of the soft outer body 110 is molded, as shown in FIG. 4, taking out the mold core 300, wherein the raw material of the soft outer body molds the soft outer body 110, and a cavity is formed in the original position of the mold core 300;
step 5: assembling the vibration motor 120, the control device 130 and the power supply unit 140 to the lower side of the positioning fixture 400, as shown in FIG. 5, and placing the positioning fixture 400 on the top of the outer mold 200, so that the vibration motor 120, the control device 130 and the power supply unit 140 are placed in the cavity;
step 6: injecting soft filler raw material into the cavity for filling;
step 7: After the soft filler raw material is formed, as shown in FIG. 6, taking out the positioning fixture 400;
step 7: taking out the positioning fixture 400; and
step 8: placing the pressing mold 500 on the top of the outer mold 200, so that the top of the soft filler raw material forms a set shape.

After the pressing mold 500 is taken out, a massaging device 100 is fabricated.

In this embodiment, the raw material of the soft outer body is liquid silica gel.

Using this fabrication method, by assembling the vibration motor 120, the control device 130 and the power supply unit 140 on the lower side of the positioning fixture 400, and placing the positioning fixture 400 on the top of the outer mold 200, the vibration motor 120, the control device 130 and the power supply are assembled. The power supply unit 140 is placed in the cavity, so that there is no need for a casing or a bracket in the cavity of the massaging device 100, which greatly reduces the foreign body sensation of the product and improves the user's experience.

As a preferred solution, between step 7 and step 8, the method further includes the step of continuing to inject the soft filler raw material to make up for the missing part. Due to the influence of the positioning fixture 400, the first injection of the soft filler raw material is inevitably missing.

As a preferred solution, after step 8, the method further includes a step of: drying and forming.

The bottom of the outer mold 200 corresponds to the massage end a of the massaging device 100, and the top of the outer mold 200 corresponds to the hand-held end b of the massaging device 100.

Referring to FIGS. 2, 5 and 6, the control device 130 is assembled to the lower side of the positioning fixture 400, the vibration motor 120 is connected to the lower side of the control device 130 through the wire 150, and the power supply unit 140 is fixedly assembled on the control device 130.

Further, the control device 130 is provided with a charging electrode 160. The positioning fixture 400 is provided with a positioning structure 420, so that the control device 130 is detachably mounted on the lower side of the positioning fixture 400, and keeps the charging electrode 160 facing the top of the outer mold 200, so as to facilitate subsequent charging of the massaging device 100. In addition, the control device 130 is provided with a push switch 180, and the push switch 180 faces the side of the outer mold 200. The positioning fixture 400 can place the vibration motor 120, the control device 130 and the power supply unit 140 in the cavity of the massaging device 100 according to the set positions, and make the charging electrode 160 face the top of the outer mold 200 and the push switch 180 face the side of the outer mold 200.

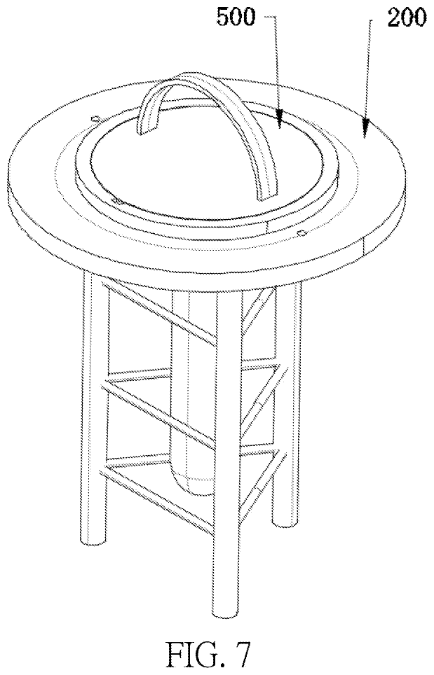

More specifically, as shown in FIG. 3 to FIG. 4, the top side of the outer mold 200 is provided with an insertion hole 210, and the lower side of the mold core 300 is provided with an insertion post 310, and the insertion post 310 is detachably inserted into the insertion hole 210. The cooperation between the insertion hole 210 and the insertion post 310 not only makes the outer mold 200 and the mold core 300 detachable, but also positions the mold core 300. In addition, the top side of the mold core 300 is provided with a first handle 320 to facilitate taking out the mold core 300. As shown in FIGS. 6 to 7, the top side of the outer mold 200 is provided with a notch 220, and the positioning fixture 400 is provided with a first bump 410 that protrudes outward and corresponds to the notch 220. By providing the notch 220 and the first bumps 410, the orientation of the positioning fixture 400 is fixed, so that both the orientation of the vibration motor 120 and the orientation of the push switch 180 are in the set position.

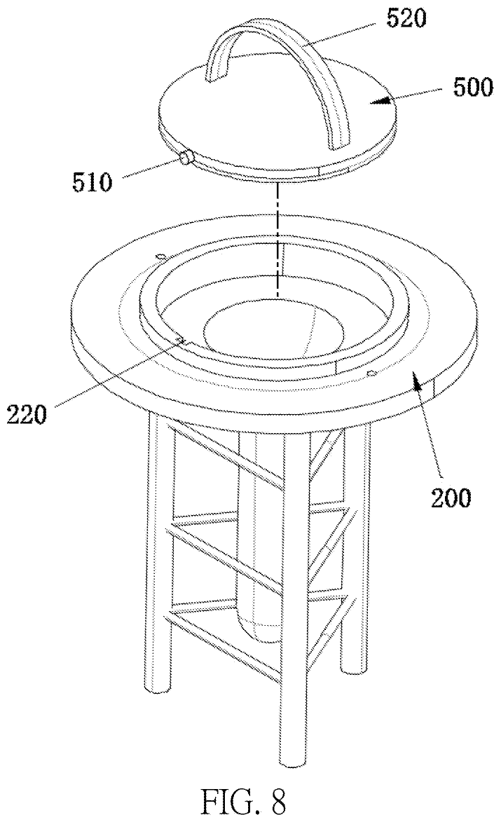

Further, as shown in FIGS. 7 to 9, the pressing mold 500 is provided with a second bump 510 that protrudes outward and corresponds to the notch 220. By providing the second bump 510, the direction of the pressing mold 500 is fixed. The top side of the pressing mold 500 is provided with a second handle 520 to facilitate the taking out of the pressing mold 500.

Further, the bottom of the pressing mold 500 is provided with a third bump 530, so that after the pressing mold 500 is placed on the top of the outer mold 200, a charging port 170 is formed on the handheld end b of the massaging device 100, and the position of the charging port 170 is corresponding to the position of the charging electrode 160.

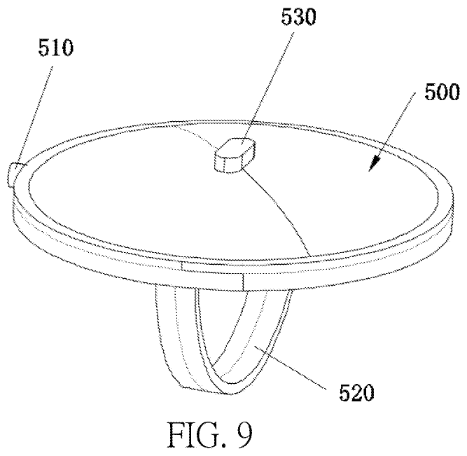

Further, as shown in FIG. 9 and FIG. 1, the bottom of the pressing mold 500 is in an arc shape with a high middle and a low circumference, so that after molding, the bottom of the hand-held end b of the massaging device is an arc shape with a low middle and a high circumference.

The working principle of the present disclosure is roughly as follows. By assembling the vibration motor 120, the control device 130 and the power supply unit 140 on the lower side of the positioning fixture 400, and placing the positioning fixture 400 on the top of the outer mold 200, the vibration motor 120, the control device The device 130 and the power supply unit 140 are arranged in the cavity according to the set positions, so that there is no need for a casing or a bracket in the cavity of the massaging device 100, which greatly reduces the foreign body sensation of the product and improves the user's experience.

The above is only used to illustrate the technical solution of the present disclosure and not to limit it. Other modifications or equivalent replacements made by those of ordinary skill in the art to the technical solution of the present disclosure, as long as they do not depart from the spirit and scope of the technical solution of the present disclosure, should be included in the within the scope of the claims of the present disclosure.

What is claimed is:

1. A massaging device, comprising:
a soft outer body having a cavity;
a vibration motor, arranged in the cavity;
a control device, arranged in the cavity and electrically connected to the vibration motor, for controlling the vibration motor to operate;
a power supply unit, arranged in the cavity and electrically connected to the control device, for supplying power to the vibration motor and the control device; and
a soft filler filled in the cavity, wherein the soft filler is configured to seal the vibration motor, the control device and the power supply unit in the cavity.

2. The massaging device according to claim 1, wherein each of the soft outer body and the soft filler is made of silica gel.

3. The massaging device according to claim 1, wherein one end of the massaging device is a massage end, and another end of the massaging device is a handheld end; the vibration motor is close to the massage end, and the control device is close to the handheld end; the vibration motor and the control device are connected to each other through a wire.

4. The massaging device according to claim 3, wherein the wire is a stretchable wire.

5. The massaging device according to claim 3, wherein the power supply unit (140) is fixedly assembled on the control device.

6. The massaging device according to claim 1, wherein a charging electrode is provided on the control device, and the charging electrode is exposed from the soft outer body.

7. The massaging device according to claim 1, wherein a push switch is provided on the control device, and the push switch faces a side of the soft outer body.

8. A method of fabricating a massaging device, comprising the following steps:
step 1: preparing an outer mold, a mold core, a positioning fixture, a pressing mold, a soft outer body raw material, a soft filler raw material, a vibration motor, a control device and a power supply unit;
step 2: assembling the mold core into the outer mold;
step 3: injecting a raw material of a soft outer body into the outer mold;
step 4: after the raw material of the soft outer body is molded, taking out the mold core, wherein the raw material of the soft outer body molds the soft outer body, and a cavity is formed in an original position of the mold core;
step 5: assembling the vibration motor, the control device and the power supply unit to a lower side of the positioning fixture, and placing the positioning fixture on a top of the outer mold so that the vibration motor, the control device, and the power supply unit are placed in the cavity;
step 6: injecting the soft filler raw material into the cavity for filling;
step 7: taking out the positioning fixture; and
step 8: placing the pressing mold on the top of the outer mold, so that a top of the soft filler raw material is formed into a set shape.

9. The method according to claim 8, wherein between step 7 and step 8, the method further includes the step of continuing to inject the soft filler raw material to fill a missing part.

10. The method according to claim 8, wherein after step 8, the method further includes a step of drying and forming.

11. The method according to claim 8, wherein a bottom of the outer mold corresponds to a massage end of the massaging device, and the top of the outer mold corresponds to a handheld end of the massaging device;
wherein the control device is assembled to the lower side of the positioning fixture, the vibration motor is connected to an lower side of the control device through a wire, and the power supply unit is fixedly assembled on the control device;
wherein a charging electrode is provided on the control device, and the charging electrode faces the top of the outer mold;
wherein a push switch is provided on the control device, and the push switch (180) faces a side of the outer mold.

12. The method according to claim 11, wherein a top side of the outer mold is provided with an insertion hole, a lower side of the mold core is provided with a insertion post, and the insertion post is detachably inserted into the insertion hole; and
a notch is formed on the top side of the outer mold, and a first bump that protrudes outward and corresponds to the notch is arranged on the positioning fixture.

13. The method according to claim 11, wherein a top side of the mold core is provided with a first handle.

14. The method according to claim 11, wherein the positioning fixture is provided with a positioning structure, so that the control device is detachably assembled on the lower side of the positioning fixture and holds the charging electrode towards the top of the outer mold.

15. The method according to claim 12, wherein the pressing mold is provided with a second bump that protrudes outward and corresponds to the notch and a top side of the pressing mold is provided with a second handle.

16. The method according to claim 11, wherein a bottom of the pressing mold is provided with a third bump, so that after the pressing mold is placed on the top of the outer mold, a charging port is formed on the handheld end of the massaging device, and the charging port corresponds to the charging electrode.

17. The method according to claim 16, wherein the bottom of the pressing mold is in an arc shape with a high middle and a low circumference, so that a bottom of the handheld end of the massaging device is an arc shape with a low middle and a high circumference.
